(19) United States
(12) Patent Application Publication
(10) Pub. No.: US 2016/0087834 A1
(43) Pub. Date: Mar. 24, 2016

(54) Smart Home System and Control Method Therefor

(71) Applicant: GREE ELECTRIC APPLIANCES, INC. OF ZHUHAI, Guangdong (CN)

(72) Inventors: Zhigang ZHAO, Guangdong (CN); Changlin LIN, Guangdong (CN); Guixian MOU, Guangdong (CN); Haichuan SONG, Guangdong (CN); Wenjun GUO, Guangdong (CN)

(21) Appl. No.: 14/785,158

(22) PCT Filed: Apr. 15, 2014
(86) PCT No.: PCT/CN2014/075391

§ 371 Date: Oct. 16, 2015

(30) Foreign Application Priority Data
Apr. 17, 2013 (CN) 201310135166.X

(51) Int. Cl. H04L 12/24; H04L 12/66; H04L 12/28

(52) U.S. Cl. CPC H04L 41/0803; H04L 12/2818; H04L 12/66; H04L 12/2807

(57) ABSTRACT

Provided are a smart home system and control method therefor, the system comprising: a client (8), a cloud server (1), a router (2), a control terminal (3), gateway devices (4), and household appliances (5). The control method comprises: a client transmits control instructions containing preset time and a scene command to the cloud server (1); the cloud server (1) transmits the control instructions to the control terminal (3) via the router (2); the control terminal (3) transmits corresponding scene command to the gateway devices (4); the gateway devices (4) receive the scene command, generate a control command, and transmit the control commands to the household appliances (5); and the household appliances (5) receive and execute the control command. The air-conditioner can be automatically controlled by simply setting a scene profile and a schedule via APP software; and the wired connection is changed into a wireless connection.

### CROSS REFERENCE TO RELATED APPLICATIONS

This application is a US 371 application from PCT/CN2014/075391 filed Apr. 15, 2014, which claims the benefit of priority of Chinese Patent Application No. 201310135166.X, filed on Apr. 17, 2013, entitled “Smart Home System and Control Method Therefor”, the entire contents of which are incorporated herein by reference.

### TECHNICAL FIELD

The present disclosure relates to the field of smart home, more particularly, to a smart home system and a control method therefor.

### BACKGROUND

With the increasing development of people's living standard, a smart home has become an important part of people's living.

Based on a house as the platform, the smart home system is a living environment which takes advantages of generic cabling technology, network communication technology, design of smart home system, security and defense technology, automatic control technology, and audio and video technology, integrates domestic-life-related facilities, and constructs a highly efficient management system for house facilities and household-related matters, so as to improve the security, convenience, comfort and artistry of home, and to realize environment protections and energy-savings.

At present, the scene profile of smart home system is mostly that the control is executed by wired devices such as a display panel, touch screen, manual controller, remote controller or centralized controller, or by short-range infrared devices such as remote controller. The disadvantages of this manner are that the control needs manual intervention and the operation mode is single. Only a minority of special models have the function of setting scene profiles, however these models have no function of setting schedules, that is, the scene profile shall be set manually every day, but cannot be automatically executed several times a day or a week.

Additionally, in many existing smart home systems, too many household electrical appliances are provided, which causes too many wires to be arranged between the gateway devices and the bottom devices (namely, the household electrical appliances). Accordingly, when the gateway devices with too many wires communicate with the control terminals, the communication lines will become more complex. What's more, communication signals transmitted via the complex communication lines are poor and the production cost of the circuits is high.

### SUMMARY

The present disclosure aims at providing a smart home system and a control method therefor. Through the combination of a scene profile and a schedule, a user can set a series of instructions which are executed automatically several times a day or a week without repeated manual settings by the user. The smart home system and the control method therefor facilitate the user in automatically and intelligently managing the smart household appliances as desired.

The objective of the present disclosure is achieved by the following technical scheme:

A smart home system comprises a client, a cloud server, a router, a control terminal, gateway devices and household appliances;

wherein, the client is configured to transmit control instructions, which comprise preset time and a scene command, to the cloud server;

the cloud server is configured to receive the control instructions, which are transmitted by the client and comprise preset time and a scene command, and transmits the control instructions to the router;

the router is configured to receive the control instructions and transmit the control instructions to the control terminal;

the router is configured to communicate with the control terminal;

the control terminal is configured to store the control instructions, judge whether current time is the preset time or not, and transmit the scene command to the gateway devices;

the gateway devices are configured to receive, decode the scene command and generate control commands, and transmit the control commands to the household appliances;

the household appliances are configured to communicate with the gateway devices, and execute the control commands.

Preferably, the client is a mobile phone, a panel computer or a laptop computer.

Preferably, the control terminal comprises a storage unit, a detecting unit and a transmit unit;

the storage unit is configured to store the control instructions containing preset time and a scene command;

the detecting unit is configured to judge whether the current time is the preset time or not; the transmit unit is configured to transmit the scene command to the gateway devices.

Preferably, the gateway devices comprise at least one of following gateways:

a CAN-RF gateway, which is connected with the household appliance via a CAN-bus;

a RS485-RF gateway, which is connected with the household appliance via a RS485-bus.

Preferably, each gateway device further comprises a feedback unit, the feedback unit is configured to receive running status data of the household appliances and transmits the data to the control terminal;

the control terminal further comprises a processing unit and a transmission unit; the processing unit is configured to analyze and process the running status data of the household appliances, and generate a command execution result;

the transmission unit is configured to transmit the command execution result and the running status data of the household appliances to the cloud server via the router;

the cloud server is configured to receive the command execution result and the running status data of the household appliances, and transmit the result and the data to the client.

Preferably, the gateway devices are configured to communicate with the control terminal through radio-frequency signals;

the control terminal are configured to communicate with the router through Wi-Fi signals;

the router is configured to communicate with the cloud server through internet;

the cloud server is configured to communicate with the client through internet, 3G, 4G, Wi-Fi or GPRS network.

A control method for smart home system comprises following steps:

transmitting, by a client, control instructions containing preset time and a scene command, to a cloud server;

transmitting the control instructions to a control terminal by the cloud server; storing the control instructions by a control terminal;
judging, by the control terminal, whether current time is the preset time or not; if yes, transmitting corresponding scene command to gateway devices;

receiving, decoding the scene command and generating control commands by the gateway devices, and transmitting the control commands to household appliances;

receiving and executing the control commands by the household appliances.

Preferably, after receiving and executing the control commands by the household appliances, the control method further comprises following steps:

sampling running status data of the household appliances in real time and transmitting the data to the control terminal by the gateway devices;

receiving and processing the running status data by the control terminal; judging whether the control commands have been executed or not; and generating a command execution result;

transmitting, by the control terminal, the command execution result and the running status data to the cloud server via the router;

receiving the command execution result and the running status data by the cloud server, and transmitting the result and the data to the client.

A control method for smart home system comprises following steps:

transmitting, by a client, control instructions containing preset time and a scene command to a control terminal through local area network bridged through a router;

storing the control instructions by the control terminal;

judging, by the control terminal, whether current time is the preset time or not; if yes, transmitting corresponding scene command to gateway devices;

receiving, decoding the scene command and generating control commands by the gateway devices, and transmitting the control commands to household appliances;

receiving and executing the control commands by the household appliances.

Preferably, after receiving and executing the control commands by the household appliances, the control method further comprises following steps:

sampling running status data of the household appliances in real time and transmitting the data to the control terminal by the gateway devices;

receiving and processing the running status data by the control terminal; judging whether the control commands have been executed or not; and generating a command execution result;

transmitting, by the control terminal, the command execution result and the running status data to a cloud server via the router;

receiving the command execution result and the running status data by the cloud server, and transmitting the result and the data to the client.

The good effects of the present disclosure are as follows:

With the above mentioned structure and the control method, the present disclosure has the following advantages:

Through the combination of a scene profile and a schedule, a user can set a series of instructions which are executed automatically several times a day or a week, without repeated manual settings by the user. The smart home system and the control method therefor facilitate the user in automatically and intelligently managing the smart home as desired. Without getting in touch with the bottom devices and without learning professional knowledge of air conditioner, the user can automatically control the smart household appliances by simply setting a scene profile and a schedule via APP software. The wired connection is changed into a wireless connection, thus the user is set free from the surrounding wires and needs not to take much effort in wiring design.

### BRIEF DESCRIPTION OF DRAWINGS

FIG. 1 is a structural schematic diagram of the smart home system of the present disclosure;

FIG. 2 is a schematic diagram of the smart home system according to one embodiment of the present invention; wherein:
1. cloud server; 2. router; 3. control terminal; 4. gateway device; 5. household appliance; 6. 485-RF gateway; 7. CAN-RF gateway; 8. client.

### DETAILED DESCRIPTION OF DISCLOSED EMBODIMENTS

In order to make the objectives, the technical schemes and advantages of the present disclosure more apparent and better understood, the present disclosure will be described in more details with reference to the accompanying figures and embodiments. It should be understood that the specific embodiments described herein are merely to explain the present invention, but not to limit the scope of the present invention.

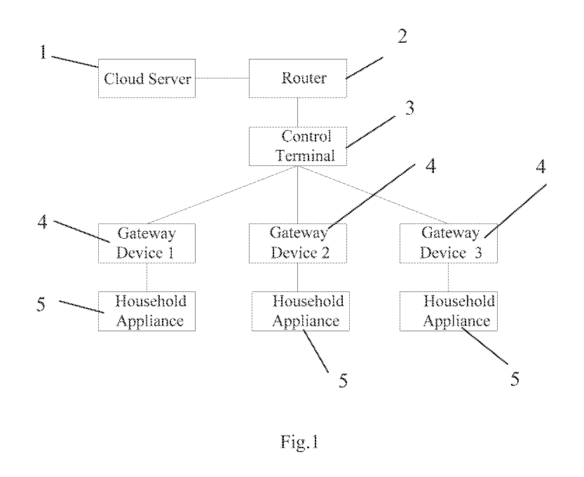

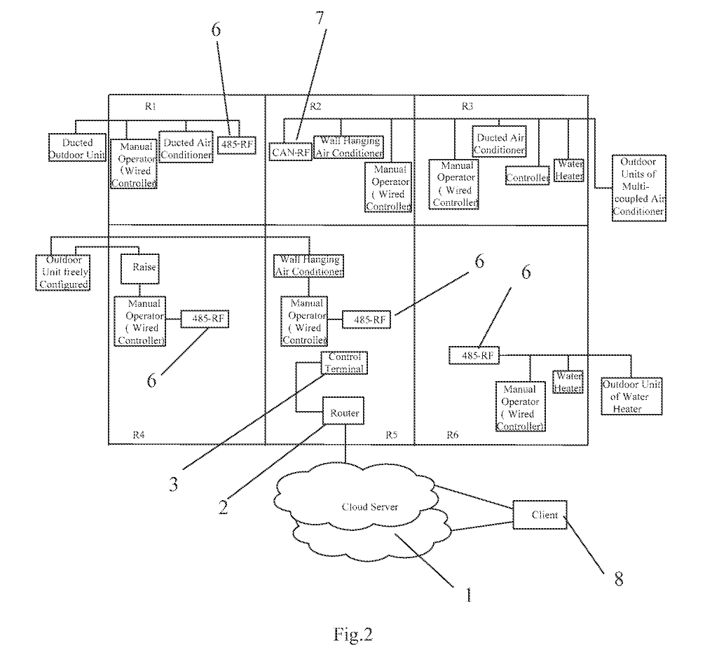

As shown in FIGS. 1 and 2, the smart home system comprises a client 8, a cloud server 1, a router 2, a control terminal 3, gateway devices 4 and household appliances 5.

The client 8 is configured to transmit control instructions containing preset time and a scene command to the cloud server 1.

The cloud server 1 is configured to receive the control instructions containing preset time and a scene command from the client 8, and transmit the control instructions to the router 2.

The router 2 receives the control instructions and transmits them to the control terminal 3.

The router 2 communicates with the control terminal 3.

The control terminal 3 stores the control instructions, judges whether the current time is the preset time or not, and transmits the scene command to the gateway devices 4.

The gateway devices 4 receive, decode the scene command and generate control commands, and transmit the control commands to the household appliances 5.

The household appliances 5 communicate with the gateway devices 4, and execute the control commands

Preferably, the client 8 is a mobile phone, a panel computer or a laptop computer.

Preferably, as a first embodiment of the present invention, the control terminal 3 includes a storage unit, a detecting unit and a transmit unit.

The storage unit is configured to store the control instructions containing the preset time and the scene command.

The detecting unit is configured to judge whether the current time is the preset time or not.

The transmit unit is configured to transmit the scene command to the gateway devices 4.

Preferably, as a second embodiment of the present invention, the gateway devices include at least one of the following gateways:

a CAN-RF gateway 7, which is connected with a household appliance via a CAN-bus; a RS485-RF gateway 6, which is connected with a household appliance via a RS485-bus.

Preferably, as a third embodiment of the present invention, each gateway device 4 further includes a feedback unit, which is configured to receive the running status data of the household appliances and transmit the data to the control terminal 3.

The control terminal 3 further includes a processing unit and a transmission unit.

The processing unit is configured to analyze and process the running status data of the household appliances 5, and generate a command execution result.

The transmission unit is configured to transmit the running status data of the household appliances 5 and the command execution result to the cloud server 1 via the router 2.

The cloud server 1 receives the running status data of the household appliances 5 and the command execution result, and transmits them to the client 8.

Preferably, as a fourth embodiment of the present invention, the gateway devices 4 communicate with the control terminal 3 through radio-frequency signals.

The control terminal 3 communicates with the router 2 through Wi-Fi signals.

The router 2 communicates with the cloud server 1 through internet.

The cloud server 1 communicates with the client 8 through the wired internet, 3G, 4G, Wi-Fi or GPRS network.

The control method for the smart home system includes following steps:

transmitting, by the client 8, control instructions containing preset time and a scene command, to the cloud server 1;

transmitting, by the cloud server 1, the control instructions to the control terminal 3 via a router 2;

storing the control instructions by the control terminal 3;

judging, by the control terminal 3, whether the current time is the preset time or not; if yes, transmitting the corresponding scene command to gateway devices 4;

receiving, decoding the scene command and generating control commands by the gateway devices 4, and transmitting the control commands to the household appliances 5;

receiving and executing the control commands by the household appliances 5.

Preferably, as a first embodiment of the control method of the present invention, after receiving and executing the control commands by the household appliances 5, the control method further includes following steps:

sampling, by the gateway devices 4, the running status data of the household appliances 5 in real time and transmitting the data to the control terminal 3;

receiving and processing the running status data by the control terminal 3; judging whether the control commands have been executed or not; and generating a command execution result;

transmitting the command execution result and the running status data by the control terminal 3 to the cloud server 1 via the router 2;

receiving the command execution result and the running status data by the cloud server 1, and transmitting them to the client 8.

Preferably, as a second embodiment of the control method of the present invention, the client 8 transmits the control instructions to the control terminal 3 through a local area network bridged through the router 2.

The control terminal 3 transmits the command execution result and the running status data to the client 8 through the local area network bridged through the router 2.

According to one embodiment of the present invention, the operations by a user are specified as follows:

installing App software in a mobile phone or a panel computer;

running and logging on the APP;

setting a scene profile on the App.

The App software transmits instructions to the cloud server, and further transmits to a Wi-Fi host.

The Wi-Fi host receives and stores the instructions, and judges whether the real-time clock is in agreement with the execution time for the operation instructions saved in the internal storage or not; if yes, the instructions are converted into RF signals and the RF signals are transmitted to RF gateways.

RF gateways decode the received RF signals into CAN-bus data or RS485-bus data, and transmit the data to the smart household appliances (e.g., an air-conditioner) so as to control the running of the household appliances.

The smart household appliances transmit the current running status data to the RF gateways. The RF gateways convert the current running status data into RF signals and transmit the RF signals to the Wi-Fi host. The Wi-Fi host decodes the received RF signals and converts the decoded signals into Wi-Fi signals. The Wi-Fi signals are transmitted to the APP software via the cloud server. The APP software displays the acquired information on an interface for the user.

The embodiments described above are merely illustrations of the present disclosure, which are described specifically and in details, but are not limiting the scope of the present invention. It should be understood by those skilled in the art that, based on the thought of the present disclosure, various modifications and improvements may be made without departing from the scope of the present disclosure. Therefore, the scope of the present invention is defined by the appended claims.

1-10. (canceled)

11. A smart home system, comprising a client, a cloud server, a router, a control terminal, gateway devices and household appliances;
wherein, the client is configured to transmit control instructions, which comprise preset time and a scene command, to the cloud server;
the cloud server is configured to receive the control instructions, which are transmitted by the client and comprise preset time and a scene command, and transmits the control instructions to the router;
the router is configured to receive the control instructions and transmit the control instructions to the control terminal;
the router is configured to communicate with the control terminal;
the control terminal is configured to store the control instructions, judge whether current time is the preset time or not, and transmit the scene command to the gateway devices;
the gateway devices are configured to receive, decode the scene command and generate control commands, and transmit the control commands to the household appliances;
the household appliances are configured to communicate with the gateway devices, and execute the control commands.

12. The smart home system according to claim 11, wherein, the client is a mobile phone, a panel computer or a laptop computer.

13. The smart home system according to claim 11, wherein,
the control terminal comprises a storage unit, a detecting unit and a transmit unit;
the storage unit is configured to store the control instructions containing preset time and a scene command;
the detecting unit is configured to judge whether the current time is the preset time or not;
the transmit unit is configured to transmit the scene command to the gateway devices.

14. The smart home system according to claim 13, wherein, the gateway devices comprise at least one of following gateways:
a CAN-RF gateway, which is connected with the household appliance via a CAN-bus;
a RS485-RF gateway, which is connected with the household appliance via a RS485-bus.

15. The smart home system according to claim 11, wherein,
each gateway device further comprises a feedback unit, said feedback unit is configured to receive running status data of the household appliances and transmits the data to the control terminal;
the control terminal further comprises a processing unit and a transmission unit;
the processing unit is configured to analyze and process the running status data of the household appliances, and generate a command execution result;
the transmission unit is configured to transmit the command execution result and the running status data of the household appliances to the cloud server via the router;
the cloud server is configured to receive the command execution result and the running status data of the household appliances, and transmit the result and the data to the client.

16. The smart home system according to claim 15, wherein,
the gateway devices are configured to communicate with the control terminal through radio-frequency signals;
the control terminal are configured to communicate with the router through Wi-Fi signals;
the router is configured to communicate with the cloud server through internet;
the cloud server is configured to communicate with the client through internet, 3G, 4G, Wi-Fi or GPRS network.

17. The smart home system according to claim 12, wherein,
each gateway device further comprises a feedback unit, said feedback unit is configured to receive running status data of the household appliances and transmits the data to the control terminal;
the control terminal further comprises a processing unit and a transmission unit;
the processing unit is configured to analyze and process the running status data of the household appliances, and generate a command execution result;
the transmission unit is configured to transmit the command execution result and the running status data of the household appliances to the cloud server via the router;
the cloud server is configured to receive the command execution result and the running status data of the household appliances, and transmit the result and the data to the client.

18. The smart home system according to claim 17, wherein,
the gateway devices are configured to communicate with the control terminal through radio-frequency signals;
the control terminal are configured to communicate with the router through Wi-Fi signals;
the router is configured to communicate with the cloud server through internet;
the cloud server is configured to communicate with the client through internet, 3G, 4G, Wi-Fi or GPRS network.

19. The smart home system according to claim 13, wherein,
each gateway device further comprises a feedback unit, said feedback unit is configured to receive running status data of the household appliances and transmits the data to the control terminal;
the control terminal further comprises a processing unit and a transmission unit;
the processing unit is configured to analyze and process the running status data of the household appliances, and generate a command execution result;
the transmission unit is configured to transmit the command execution result and the running status data of the household appliances to the cloud server via the router;
the cloud server is configured to receive the command execution result and the running status data of the household appliances, and transmit the result and the data to the client.

20. The smart home system according to claim 19, wherein,
the gateway devices are configured to communicate with the control terminal through radio-frequency signals;
the control terminal are configured to communicate with the router through Wi-Fi signals;
the router is configured to communicate with the cloud server through internet;
the cloud server is configured to communicate with the client through internet, 3G, 4G, Wi-Fi or GPRS network.

21. The smart home system according to claim 14, wherein,
each gateway device further comprises a feedback unit, said feedback unit is configured to receive running status data of the household appliances and transmits the data to the control terminal;
the control terminal further comprises a processing unit and a transmission unit;
the processing unit is configured to analyze and process the running status data of the household appliances, and generate a command execution result;
the transmission unit is configured to transmit the command execution result and the running status data of the household appliances to the cloud server via the router;
the cloud server is configured to receive the command execution result and the running status data of the household appliances, and transmit the result and the data to the client.

22. The smart home system according to claim 21, wherein,
the gateway devices are configured to communicate with the control terminal through radio-frequency signals;
the control terminal are configured to communicate with the router through Wi-Fi signals;
the router is configured to communicate with the cloud server through internet;
the cloud server is configured to communicate with the client through internet, 3G, 4G, Wi-Fi or GPRS network.

23. A control method for smart home system, comprising following steps:
transmitting, by a client, control instructions containing preset time and a scene command, to a cloud server;
transmitting the control instructions to a control terminal by the cloud server;
storing the control instructions by a control terminal;
judging, by the control terminal, whether current time is the preset time or not; if yes, transmitting corresponding scene command to gateway devices;
receiving, decoding the scene command and generating control commands by the gateway devices, and transmitting the control commands to household appliances;
receiving and executing the control commands by the household appliances.

24. The control method for smart home system according to claim 23, wherein, after receiving and executing the control commands by the household appliances, the control method further comprises following steps:
sampling running status data of the household appliances in real time and transmitting the data to the control terminal by the gateway devices;
receiving and processing the running status data by the control terminal; judging whether the control commands have been executed or not; and generating a command execution result;
transmitting, by the control terminal, the command execution result and the running status data to the cloud server via the router;
receiving the command execution result and the running status data by the cloud server, and transmitting the result and the data to the client.

25. A control method for smart home system, comprising following steps:
transmitting, by a client, control instructions containing preset time and a scene command to a control terminal through local area network bridged through a router;
storing the control instructions by the control terminal;
judging, by the control terminal, whether current time is the preset time or not; if yes, transmitting corresponding scene command to gateway devices;
receiving, decoding the scene command and generating control commands by the gateway devices, and transmitting the control commands to household appliances;
receiving and executing the control commands by the household appliances.

26. The control method for smart home system according to claim 25, wherein, after receiving and executing the control commands by the household appliances, the control method further comprises following steps:
sampling running status data of the household appliances in real time and transmitting the data to the control terminal by the gateway devices;
receiving and processing the running status data by the control terminal; judging whether the control commands have been executed or not; and generating a command execution result;
transmitting, by the control terminal, the command execution result and the running status data to a cloud server via the router;
receiving the command execution result and the running status data by the cloud server, and transmitting the result and the data to the client.
